(19) United States
(12) Patent Application Publication
(10) Pub. No.: US 2020/0182391 A1
(43) Pub. Date: Jun. 11, 2020

(54) Method and Assembly for Repairing Underground Structures

(71) Applicant: LMK Technologies, LLC, Ottawa, IL (US)

(72) Inventors: Andrew Kennard, Ottawa, IL (US); Zach W. Walter, Ottawa, IL (US); Dan Casey, Sheridan, IL (US)

(73) Assignee: LMK Technologies, LLC, Ottawa, IL (US)

(21) Appl. No.: 16/214,641

(22) Filed: Dec. 10, 2018

(51) Int. Cl. F16L 55/165; F16L 55/18; F16L 55/179

(52) U.S. Cl. CPC F16L 55/1654; F16L 55/179; F16L 55/18

(57) ABSTRACT

A repair assembly and method for repairing a damaged portion of a pipe. The repair assembly includes a launcher having a positioning member with a first end and a second end. The launcher further includes a first member secured at or near the first end of the positioning member and a second member combined with the positioning member between its first end and its second end. A bladder assembly and a liner assembly are secured to the launcher between the first member and the second member. The second member may include an opening adapted to receive the positioning member so that the second member is slidable along the length of the positioning member to adjust the distance between the first member and the second member and help accommodate different lengths of bladders and liners. The second member may also include an inlet/outlet opening adapted to be connected to a hose for pressurizing or deflating the bladder with air or any other suitable fluid.

### FIELD OF THE INVENTION

The invention relates generally to an apparatus and method for repairing or sealing an opening in a pipe such as a damaged pipe portion or the junction between two pipes. More particularly, but not exclusively, the invention relates to a kit, assembly, apparatus, and method for positioning a liner at an opening in a pipe which may be a damaged portion of pipe or the junction between two pipes.

### BACKGROUND

As the infrastructure of major cities and towns in the developed world age, the sewer systems weaken. Pipe degradation, system blockage, water infiltration, and sewer leakage are major problems that aging sewer systems experience. As these problems persist, the sewer system may eventually experience total failure and entire sections of the sewer system may collapse. As a result, sinkholes may form and sewers may back up into homes and places of business. One method of addressing this critical infrastructure problem is the use of pipe lining techniques to rehabilitate existing sewer systems.

Cured-in-place pipelining is one such technique that includes rehabilitating an existing sewer system by creating a new pipe within an existing pipe. A liner, impregnated with a resinous material capable of curing and hardening, is inverted, pushed, or pulled into a damaged pipe. The liner is pressed toward the wall of the existing pipe, and the resinous material is allowed to cure and harden. The result is a replacement pipe having the older pipe or “host pipe” on the exterior. The cured-in-place pipe acts to alleviate the problems caused by structural defects and blockages in the existing sewer system. Some assemblies include fluid impervious bladders which are inflated to press the liner toward the wall of the existing pipe. Such bladders are typically made from polyurethane (PU) or polyvinyl chloride (PVC).

As mentioned, one existing method for repairing a damaged pipe section includes pushing a launcher or packer into a pipe until it reaches the damaged pipe section. An inflatable bladder is combined with the launcher then a resin impregnated liner is wrapped around or pulled over the bladder. The launcher is pushed into the pipe using a rod until the launcher reaches the desired location. Once positioned, the bladder is inflated to press the liner against the wall of the pipe as explained in the previous paragraph. One problem with existing push-in-place methods is that the rods are rigid which means the launcher is generally only able to travel laterally within a single pipe. In other words, the rod is unable to push the launcher around corners within the underground pipe system. Another problem is that many existing methods require at least two access points. One access point for launching the launcher, another access point to pull or rotate the launcher, and another access point to deploy a camera or other means for visually inspecting the launcher.

Therefore, a need in the art exists for a new apparatus and method for effectively repairing an opening in a pipe which may be a crack in a length of pipe or the junction between two buried pipes.

### SUMMARY

It is therefore an object, feature, and/or advantage of the present invention to provide an improved assembly and method for repairing or sealing underground structures, or the junction between two underground structures, which overcomes deficiencies in the prior art.

It is another object, feature, and/or advantage of the present invention to provide an improved assembly and method for repairing or sealing a pipe or the junction between two pipes by pushing a launcher from a single access point.

It is another object, feature, and/or advantage of the present invention to provide an improved assembly and method for repairing or sealing a pipe or the junction between two pipes by pushing the launcher around corners within the pipe system.

It is another object, feature, and/or advantage of the present invention to provide an improved assembly and method for repairing or sealing a pipe or the junction between two pipes by guiding or steering the launcher from a first pipe having an access point to a second pipe having a damaged section.

It is another object, feature, and/or advantage of the present invention to provide an assembly and method for repairing a pipe which is economical to manufacture, easy to install, and durable in use.

These and/or other objects, features, and advantages of the present invention will be apparent to those skilled in the art. The present invention is not to be limited to or by these objects, features and advantages, and no single embodiment need exhibit every object, feature, and/or advantage.

According to one aspect of the invention, a repair assembly for repairing a pipe comprising a launcher assembly having a flexible positioning member combined with a first member and a second member, wherein the second member is slidable along a length of the positioning member to adjust a distance between the first member and the second member. The repair assembly further includes a bladder assembly having a first portion combined with the first member and a second portion combined with the second member and a liner assembly surrounding a portion of the bladder assembly.

According to another aspect of the invention, a method for repairing a damaged section of pipe, the method comprising taking a launcher assembly having a positioning member combined with a first member and a second member, a bladder assembly combined with the first member and the second member, and a liner assembly impregnated with a resinous material capable of curing and hardening and surrounding at least a portion of the bladder assembly, wherein the positioning member has a proximal end and a distal end and pushing the launcher assembly into a first pipe using the positioning member. Then, rotating the proximal end of the positioning member to cause the distal end of the positioning member to rotate in the same direction, introducing a fluid to expand the bladder assembly to press the pipe liner against a wall of the damaged section of pipe, and allowing the resinous material to cure and harden.

According to another aspect of the invention, a repair assembly for repairing a damaged portion of a pipe is provided. The repair assembly includes a launcher for positioning a liner assembly within the pipe. The launcher includes a positioning member, such as a flexible rod or cable, having a first end and a second end. The launcher further includes a first member secured at or near the first end of the positioning member and a second member combined with the positioning member between its first end and its second end. A fluid impermeable barrier member such as a plastic sheath is placed on the positioning member between the first member and the second member. A bladder assembly and a liner assembly are secured to the launcher between the first member and the second member. In some embodiments the second member includes an opening adapted to receive the positioning member so that the second member is slidable along the length of the positioning member to adjust the distance between the first member and the second member and help accommodate different lengths of bladders and liners. Some embodiments include a camera combined with the launcher or positioning member to help remotely monitor, steer, and align the launcher in its proper position adjacent to the damaged pipe section. Further, in some embodiments the second member includes an inlet/outlet opening adapted to be connected to a hose for pressurizing or deflating the bladder with air or any other suitable fluid.

According to another aspect of the invention, a method for repairing a damaged portion of pipe is provided. The method includes providing a repair assembly including a launcher for positioning a liner assembly at a damaged portion of pipe. The launcher includes a positioning member, such as a flexible rod or cable, having a first end and a second end. The launcher further includes a first member secured at or near the first end of the positioning member and a second member combined with the positioning member between its first end and its second end. A bladder assembly is combined with the launcher between the first member and the second member. The liner assembly is impregnated with a material capable of curing and hardening then the liner assembly is secured to the launcher over at least a portion of the bladder. The launcher is pushed into a pipe from a single access point to the desired position within the pipe system adjacent to the damaged section of pipe. The single access point may be a pipe, a manhole, a cleanout, a riser, or any other suitable access point into the pipe system. The positioning member is flexible thereby allowing the launcher and positioning member to be pushed around corners and move from a first pipe into a second pipe at tee or wye intersections. Some embodiments include steering or guiding the launcher around corners or from a first pipe to a second pipe by twisting the proximal end of the positioning member at the access point. The twisting motion rotates the entire positioning member from the access point all the way to the launcher on the distal end. In this manner, the user can guide the launcher left, right, up, down or any other desired direction to help the launcher follow the correct pipe path to the damaged pipe section. Once the launcher is properly positioned with the pipe, a fluid such as air is forced into the launcher to inflate the bladder to help position liner assembly against the wall of the pipe as the resin in the liner cures and hardens. The bladder assembly may be deflated and removed from the pipe after the liner has cured and hardened.

### BRIEF DESCRIPTION OF THE DRAWINGS

FIG. 1 is a side view of an embodiment the launcher assembly.

FIG. 2 is a side view of the first member.

FIG. 3 is a side view of the second member.

FIG. 4 is an end view of the second member.

FIG. 5A is a side view of another embodiment of the launcher assembly.

FIG. 5B is a side view of the embodiment shown in FIG. 5A after the positioning member has been rotated to turn the launcher assembly.

FIG. 6 is a perspective view of an embodiment of the launcher assembly.

FIG. 7 is a sectional view of an embodiment of the launcher assembly showing the launcher positioned adjacent to the damaged pipe section where the damaged section of pipe is at the intersection of two pipes.

FIG. 8 is a sectional view similar to FIG. 7 but showing the bladder assembly and liner assembly in their inflated position.

FIG. 9 is a sectional view similar to FIG. 8 but showing an embodiment with a different sealing member.

FIG. 10 is a sectional view of an underground sewer system where the launcher has been guided from a cleanout through different pipes to its desired position adjacent to the damaged pipe section.

FIG. 11 is a sectional view showing another embodiment of the invention where the damaged pipe section is in a straight length of pipe.

FIG. 12 is a sectional view similar to FIG. 11 showing the liner in its inflated position.

### DETAILED DESCRIPTION

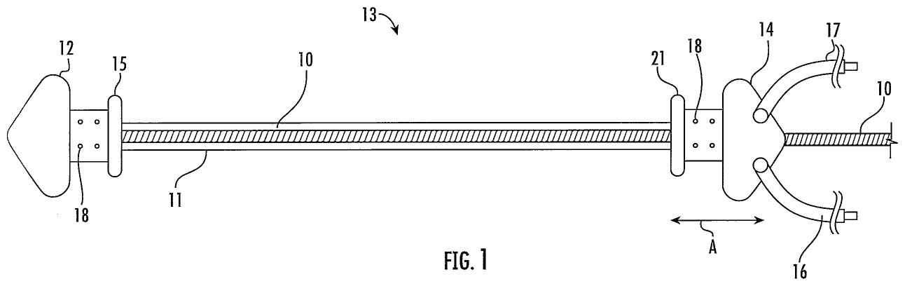

The invention generally relates to methods and assemblies for more effectively sealing underground structures such as pipes, or the junction between underground structures. As shown in FIG. 1, the invention relates to a repair assembly which includes a launcher assembly 13 for positioning a liner assembly at a damaged section 52 of pipe. The launcher assembly 13 includes a positioning member 10 having a first end and a second end. The launcher assembly 13 further includes a first member 12 combined with the positioning member 10 at or near its first end and a second member 14 combined with the positioning member 10 between its first end and its second end. The first member 12 and second member 14 may be made from aluminum or any other suitable material.

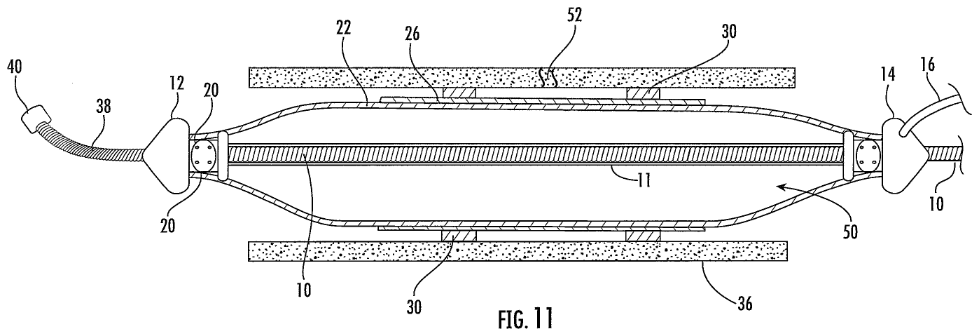

The positioning member 10 may be any suitable elongated flexible member such as a rod or cable. The positioning member is flexible, however, it may have a plastic sheath over some or all of its length to add some rigidity and help protect it from corrosion or other damage. The sheath covering the length of the positioning member 10 may be similar to barrier member 11. The positioning member 10 may be able to rotate within the sheath so that rotation of the positioning member 10 (explained herein) does not rotate the sheath. In some embodiments the positioning member 10 is between about five and seventy-five feet long in order to reach the damaged section of pipe within the pipe system. Multiple segments of the positioning member 10 may be secured together using a coupler 54. As shown in FIG. 10, the coupler 54 may be used near the launcher 13 to allow the launcher 13 to be disconnected from the rest of the positioning member 10. In some embodiments the positioning member 10 is sewer cable which may be unwound from a reel as the launcher 13 is pushed into the pipe. More specifically, in some embodiments the positioning member 10 is a ½ (one-half) inch sewer cable. Regardless of the type of material, the positioning member 10 is rigid enough to allow a user to push it into pipe with the launcher 13 on the leading (distal) end, yet flexible enough to round corners within the sewer system. More specifically, the positioning member 10 has significant strength and rigidity along its longitudinal axis L allowing it to be pushed into a pipe, however, it also easily flexes when forces are applied at an angle to its longitudinal axis L. In this manner, the positioning member 10 acts somewhat like a spring.

As shown in FIG. 1, in some embodiments a flexible barrier member 11 surrounds the positioning member 10 between the first member 12 and the second member 14. The barrier member 11 is made from an air impermeable material and may be a plastic or rubber hose or a section of bladder material. The barrier member 11 helps ensure the cavity 50 within the bladder assembly is fluid tight so that air does not escape from the cavity 50 through the positioning member 10 when the bladder assembly is pressurized. Similarly, the barrier member 11 helps prevent air form leaking into the cavity 50 through the positioning member 10 when vacuum is applied to reduce the pressure within the bladder assembly.

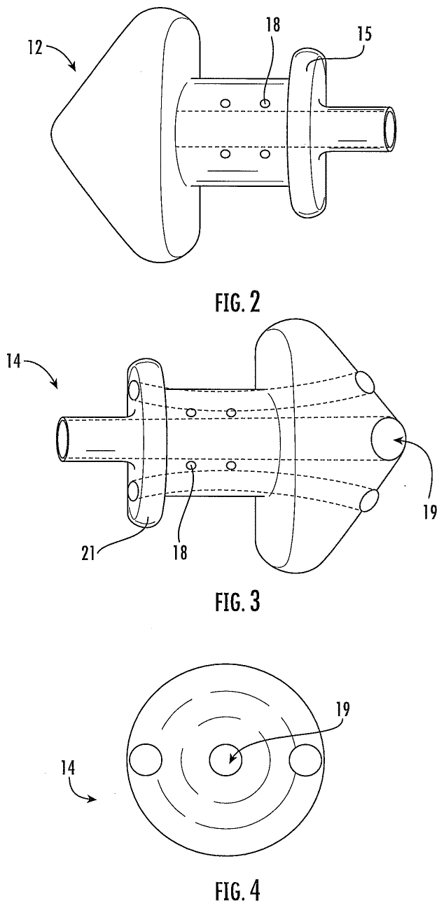

FIG. 2 shows the first member 12. The first member 12 may have a rounded or conical shape to reduce friction with the pipe and help lead the launcher 13 around corners as the launcher 13 is pushed into the pipe system. The first member 12 may be combined with the positioning member 10 by any suitable means. In the embodiment shown, the positioning member 10 is received into an opening near the center of the first member 12. One or more set screws 18 are tightened against the positioning member 10 to secure the components together. The first member 12 may include a flange 15 to help seal the main bladder tube 22 thereto as discussed in more detail below.

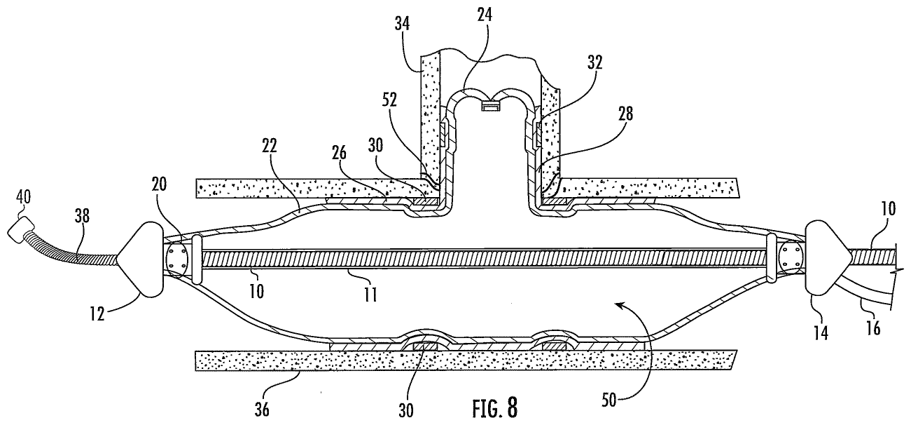

FIGS. 3 and 4 show the second member 14. The second member 14 may be combined with the positioning member 10 by any suitable means. In one embodiment the second member 14 includes an axial opening 19 through its entire length. The positioning member 10 passes through the opening 19 thereby allowing the second member 14 to slide along a longitudinal axis L of the positioning member 10 as shown by arrow A in FIG. 1. Any suitable means may be used to secure the second member 14 to the desired position along the length of the positioning member 10. In one embodiment, one or more set screws 18 are tightened against the positioning member 10 to secure the components together. Movement of the second member 14 along the length of the positioning member 10 allows the assembly to be adjusted to accommodate liner/bladder assemblies of different lengths. In other words, the second member 14 may be moved closer to the first member 12 for shorter liner/bladder assemblies and farther from the first member 12 for larger liner/bladder assemblies. In this manner the single launcher 13 is capable of being used to repair different sizes and shapes of damaged pipe sections, including pipe junctions as shown in FIG. 8 and straight lengths of pipe as shown in FIG. 11. In other embodiments the second member 14 more closely resembles the first member 12 in that it does not have an axial opening through its entire length and is not slidable along the length of the positioning member 10. In some embodiments the second member 14 further comprises one or more additional openings adapted to combine with fluid pressure 16 or vacuum 17 sources as described in more detail below. The second member 14 may include a flange 21 to help seal the main bladder tube 22 thereto as discussed in more detail below.

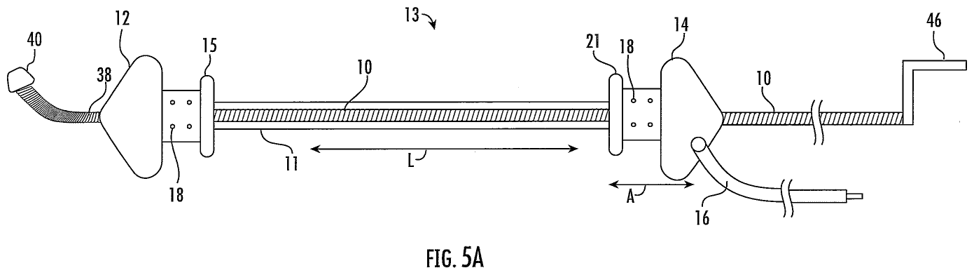

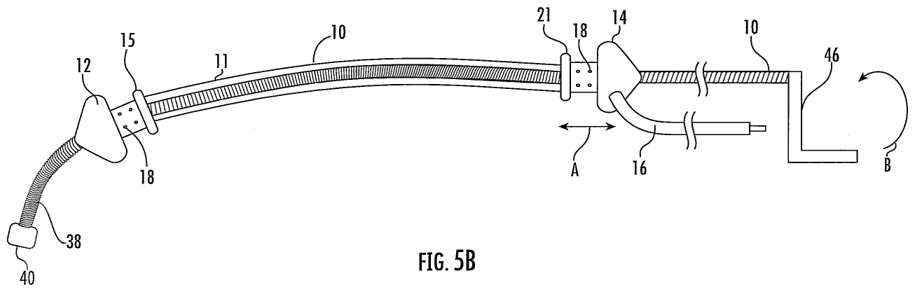

FIGS. 5A and 5B show an alternate embodiment of the launcher assembly 13. This embodiment includes some additional features which may be used together or separately in different embodiments. As shown, the first member 12 or the distal end of the positioning member 10 has a guide member 38 extending therefrom. The guide member 38 may be attached to the first member 12 by any suitable means, including an adhesive, a set screw, or by threading the guide member 38 into an opening in the end of the first member 12. The guide member 38 includes an angled portion which extends at an angle between about ten and about eighty degrees from the longitudinal axis L of the positioning member 10. In one embodiment the guide member 38 is angled between about thirty and about sixty degrees from the longitudinal axis L of the positioning member 10. In one embodiment the guide member 38 is angled about forty-five degrees from the longitudinal axis L of the positioning member 10. A rigid elbow member (not shown) may be secured to the guide member 38 to hold the guide member 38 at the desired angle. The guide member 38 may be flexible and may be a spring. In one embodiment the guide member 38 is a sewer cable which is the same diameter or small than the diameter of the positioning member 10. The angle of the guide member 38 and the position of the leading end of the guide member 38 offset from the longitudinal axis L of the positioning member 10 helps lead the launcher 13 around corners and into different pipes. Some embodiments further include a guide bead 40 combined with the guide member 38. The guide bead 40 has a round or conical shape to help reduce friction as the device is maneuvered around corners and through different pipes.

In some embodiments the guide member 38 is the distal end of the positioning member 10. In this embodiment, the first member 12 includes an axial opening (not shown) through its entire length similar to opening 19 in the second member 14. The axial opening in the first member 12 allows the positioning member 10 to extend through the first member 12 a predetermined distance. In this embodiment the distal end of the positioning member 10 is angled relative to the longitudinal axis L of the positioning member 10 and may include the guide bead 40 as described in the previous paragraph.

Another feature shown in FIGS. 5A and 5B is handle 46. The handle 46 is combined with the proximal end of positioning member 10 where the user is stationed at the pipe access point as shown in FIG. 10. The handle 46 may be easily combined with and removed from the positioning member 10 using any suitable means, such as a clamping means or set screws, so that it may be quickly attached to the positioning member 10 when the launcher 13 reaches its desired location within the pipe. As can be seen by comparing FIGS. 5A and 5B, rotating the handle 46 as shown by arrow B in FIG. 5B at the proximal end of the positioning member 10 causes the launcher 13 and guide member 38 to correspondingly rotate at the distal end of the positioning member 10. The handle 46 is not necessary in all embodiments. For example, in some embodiments the proximal end of the positioning member 10 is rotated by hand to achieve the same effect at the distal end of the positioning member 10. Although the handle 46 is not necessary in all embodiments, the handle 46 is a convenient way for the user to rotate the positioning member 10 in a desired direction to help guide the launcher 13 around corners and into different pipes within the pipe system. In embodiments having a sheath covering the length of the positioning member 10, the positioning member 10 is able to freely rotate within the sheath so that rotation of the positioning member 10 and launcher 13 does not cause the sheath to rotate.

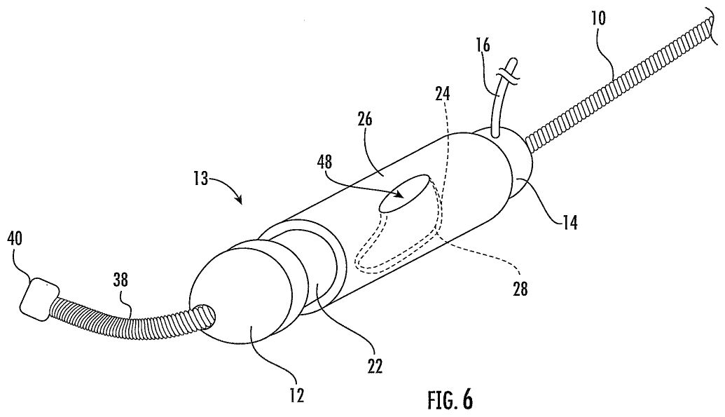

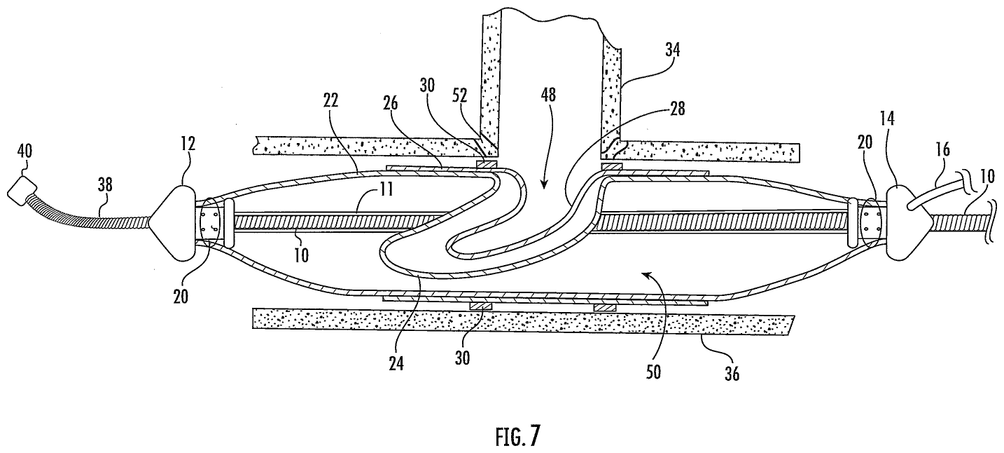

FIG. 6 shows a launcher assembly 13 having mounted thereto a T-shaped or Y-shaped liner assembly. In some embodiments the repair assembly also houses a T-shaped or Y-shaped bladder assembly. The T-shaped or Y-shaped bladder assembly includes a main bladder tube 22 and a lateral bladder tube 24. Similarly, the T-shaped or Y-shaped liner assembly includes a main liner member 26 and a lateral liner tube 28. In the particular configuration shown in FIGS. 7-9, the liner assembly and bladder assembly are T-shaped, but they can also be Y-shaped (as shown in FIG. 10) to accommodate a lateral pipe line that intersects with a first or main pipe line 36 at an oblique angle. The bladder assembly is fitted on the interior of the liner assembly.

As can be seen in FIG. 6, the main liner member 26 is comprised of what is initially a flat sheet of material which is wrapped around the outside of the main bladder tube 22 and the launcher assembly 13. The main liner member 26 may include overlapping edges. The bladder assembly includes an opening 48 and the lateral liner tube 40 is contained within as shown in FIGS. 6 and 7. Similarly, the lateral bladder tube 24 is contained within the cavity 50 and surrounds the lateral liner tube 28. Both the main liner member 26 and the lateral liner tube 28 are comprised of a felt layer, which is the lining surface that contacts the interior surface of the host pipe, and a polymer coating is on the opposite surface.

Securing members 30 such as rubber bands, frangible materials such as snaps or VELCRO, or sealing members may be used to help secure the liner/bladder assembly in place as the launcher assembly 13 is pushed into the pipe system. FIGS. 7 and 8 show one or more band-shaped sealing members 30 positioned on either side of the lateral liner opening. The sealing members 30 extend around the entire liner/bladder assembly to help secure the assembly in place and secure the assembly to the launcher 13 as it travels to its desired position. In embodiments where the securing members 30 are sealing members, the sealing members may be used to help secure the liner/bladder assembly to the launcher 13 and also to help prevent this seepage of ground water. The sealing member is preferably made of or impregnated with a hydrophilic material capable of swelling in response to being exposed to water or other liquid. However, other materials for the sealing member found suitable include neoprene rubber, other similar gasket materials such as urethane or silicone rubber, and like impermeable compressible materials. The sealing member can be attached by means of stitching, stapling, or by use of an adhesive or similar attachment means. FIG. 8 shows additional sealing member 32 which may similarly be positioned about a portion of the lateral bladder 24/lateral liner 28 to help secure the components in place and help prevent seepage of ground water.

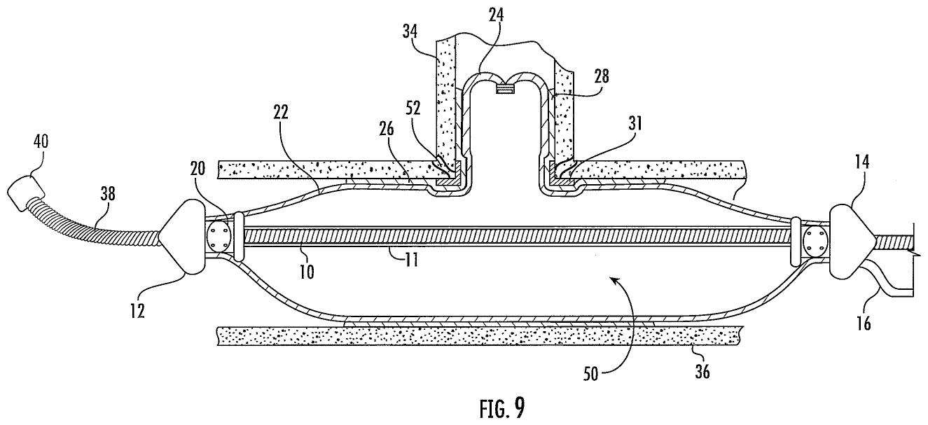

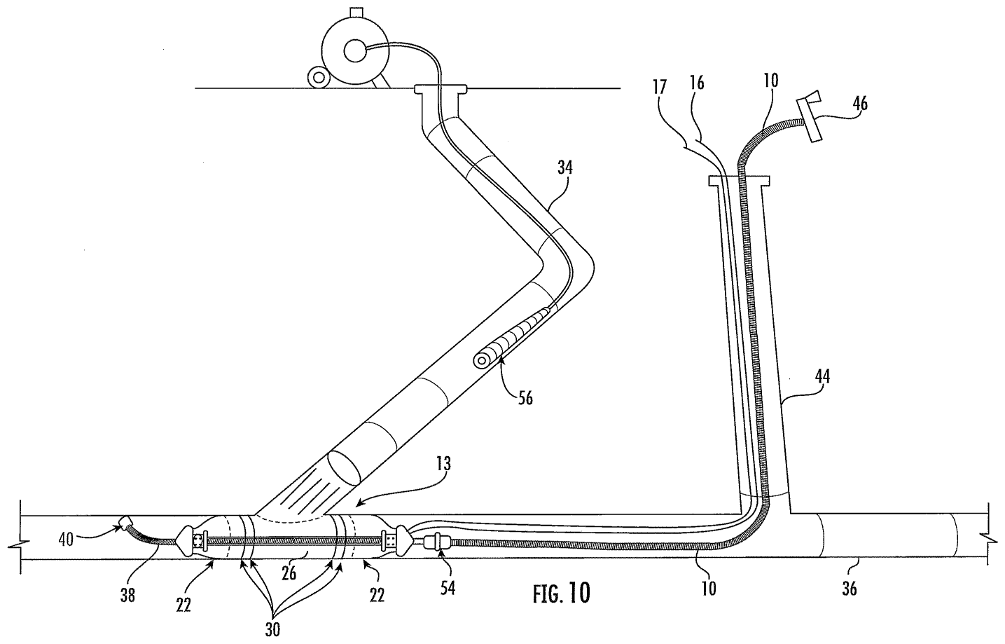

Alternate sealing members may be used at the main/lateral junction. In one embodiment the sealing member is a doughnut-shaped member wherein the opening in the middle corresponds with the lateral pipe opening. FIG. 9 shows an alternate sealing member 31 which includes a tubular portion that extends at least partially within the second or lateral pipe 34 and a flange portion that extends outwardly about the periphery of one end of the tubular portion to engage a portion of the first or main pipe 36. The flange portion of the sealing member 31 is preferably attached to the main liner member 26 around the juncture between the main liner member 26 and the lateral liner tube 28 so as to maintain the sealing member 31 in proper position as the repair assembly is positioned for operation. The sealing member 31 is preferably made of or impregnated with a hydrophilic material capable of swelling in response to being exposed to water or other liquid. However, other materials for the sealing member 31 found suitable include neoprene rubber, other similar gasket materials such as urethane or silicone rubber, and like impermeable compressible materials.

FIG. 7 shows the repair assembly moved within the first or main pipe line 36 adjacent the second or lateral pipe line 34. The damaged portion 52 is shown needing repair. Ground water from outside the lateral pipe line 34 and the main pipe line 36 will seep through the damaged portion 52 and enter the interior of the main pipe line 36 and the lateral pipe line 34. The opening 48 in the liner/bladder assemblies is registered with a junction between a lateral pipe line 34 and the main pipe line 36. The opening 48 may be aligned with the junction by rotating the proximal end of the positioning member 10 and/or the handle 46. This alignment may be done with a camera 56 inserted separately into the pipeline or combined with the launcher 13. The lateral bladder tube 24 and the lateral liner tube 28 are contained within the launcher device cavity 50. It should be noted that the lateral liner tube 28 extends within the lateral bladder tube 24 in FIGS. 6 and 7; whereas, the main liner member 26 (which may be a tube) remains outside the main bladder tube 22 on the exterior of the launcher assembly 13.

After the launcher 13 is properly positioned within the pipe system, air pressure is introduced in the cavity 50 through air hose 16, urging the liner assembly into contact with the interior walls of the main pipe line 36 and the lateral pipe line 34. Continued air pressure causes the lateral bladder tube 24 and the lateral liner tube 28 to invert outwardly through the opening 48 into the lateral pipe line 34 from the position shown in FIG. 7 to the position shown in FIG. 8. While air is the preferred pressurized material, other gasses or fluids may be used. It should be noted that this inversion process causes the lateral liner tube 28 to be placed on the outside of the bladder tube 24 once the inversion is complete, as shown in FIG. 8. In this position, the sealing member 30 is positioned between the main liner 26 and the interior walls of the main pipe line 36 and sealing member 31, 32 is further positioned between the lateral liner 28 and the interior walls of the lateral pipe line 34. Pressure within cavity 50 is maintained until the liquid hardenable material, preferably a resin activated with a catalyst, cures and hardens. This results in the liner assembly assuming a rigid configuration, forming a lining to the lateral pipe line 34 and the main pipe line 36.

Ground water can seep towards the hydrophilic sealing member 30, 31, 32. However, upon encountering the sealing member 30, 31, 32 the water causes the sealing member 30, 31, 32 to expand in both a radial inward direction and a radial outward direction. This causes the sealing member 30, 31, 32 to form a water tight seal between the T-shaped or Y-shaped liner assembly and the interior walls of the main pipe line 36 and/or the lateral pipe line 34.

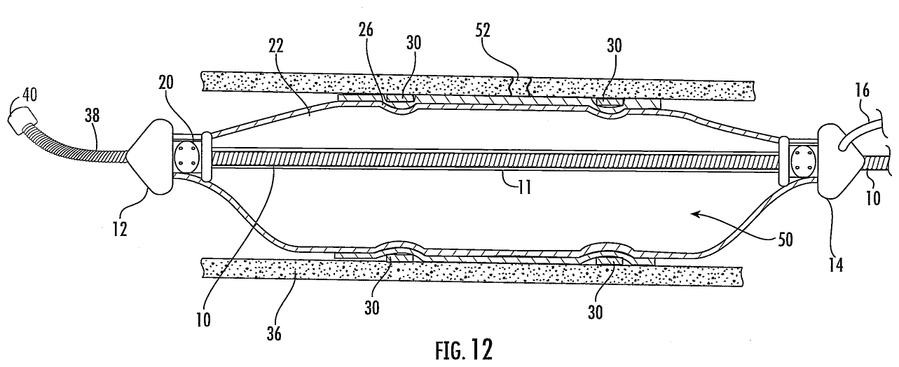

FIGS. 11 and 12 illustrate another version of the present invention for lining a damaged section of pipe that is not at a pipe junction. This embodiment is similar to the embodiments described above except the liner assembly includes a main liner member 26 and the bladder assembly includes main bladder 22, but the respective liner/bladder assemblies do not include lateral portions for lining lateral pipes. All of the features described above may also be used to position the launcher assembly 13 and repair a damaged section 52 in a length of pipe 36 when the damaged section 52 is not at a pipe junction.

The method of using the assemblies described above include providing a repair assembly including a launcher assembly 13 for positioning a liner assembly at a damaged portion of pipe. The launcher assembly 13 includes a positioning member 10, such as a flexible rod or cable, having a first end and a second end. The launcher assembly 13 further includes a first member 12 secured at or near the first end of the positioning member 10 and a second member 14 combined with the positioning member 10 between its first end and its second end. A user may inspect the damaged pipe section using a camera 56 or other suitable means to determine the size and extend of the repair. The second member 14 is then slid along the length of the positioning member 10 to create the proper distance between the first member 12 and the second member 14 for the repair. A bladder assembly is created to approximate the distance between the first member 12 and the second member 14 then the bladder assembly is combined with the launcher assembly 13 between the first member 12 and the second member 14. In one embodiment the bladder assembly includes a main bladder tube 22 which is combined to the launcher assembly 13 by securing a first end of the bladder tube 22 to the first member 12 and securing a second end of the bladder tube 22 to the second member 14 to create a fluid seal between the bladder tube 22 and the members 12, 14. The bladder tube 22 may be combined with the members 12, 14 by any suitable connecting means 20, including mechanically and/or adhesively. For example, tape may be used to seal the bladder tube 22 to the members 12, 14 and a hose clamp may be secured over the tape to help create a fluid tight seal between the bladder tube 22 and the members 12, 14. All of these connecting means are designated with reference number 20 in FIGS. 7-9 and 11-12. Flanges 15, 21 may help secure the bladder tube 22 to the members 12, 14 and create the fluid tight seal between the components.

One or more securing or sealing members 30, 31 may be secured around the main liner member 26 and/or the lateral liner tube 28. The sealing members 30, 31 help secure the components together as the launcher 13 travels through the pipe system. In addition, the sealing members 30, 31 help provide a water tight seal between the liner 26, 28 and the pipe 34, 36 as explained above in more detail.

The liner assembly is impregnated with a material capable of curing and hardening as is known in the art then the liner assembly is secured to the launcher 13 over the bladder assembly. The launcher 13 is pushed into a pipe from a single access point to the desired position adjacent to the damaged section of pipe by pushing on the positioning member 10. The single access point may be a pipe, a manhole, a cleanout 44, a riser, or any other suitable access point into the pipe system. In some embodiments the launcher 13 may be pushed into the pipe system using a robot. The positioning member 10 may be a flexible or semi-rigid cable wound around a spool or reel. The positioning member 10 is unwound from the reel as the launcher 13 is pushed into the pipe. In other embodiments the positioning member 10 is pushed into the pipe but not unwound from a spool.

As shown in FIG. 10, sometimes the damaged section of pipe is not the same pipe that is the access point for the launcher 13. This requires the launcher 13 to be guided around corners and into other pipes at tee or wye intersections. Steering or guiding the launcher 13 around corners or from a first pipe to a second pipe may be accomplished by twisting the proximal end of the positioning member 10 at the access point. The twisting motion rotates the entire positioning member 10 from the access point all the way to the launcher on the distal end. In this manner, the user can guide the launcher 13 left, right, up, down or any other desired direction to help the launcher 13 follow the correct pipe path to the damaged pipe section. Some embodiments include a handle 46 combined with the positioning member 10 at the proximal end and the method further includes rotating the handle 46 to cause the corresponding rotation of the launcher 13 at the distal end.

The main bladder 22 and/or main liner member 26 may contact the access pipe 44 and/or branch pipes 34 during instillation, especially as the components go around corners or are guided into other pipes. This contact may result in significant friction between the launcher 13 and the pipes 34, 36. In one embodiment, a vacuum is applied to remove air from the internal cavity 50 inside the bladder 22 through air hose 16 or vacuum hose 17 while the launcher 13 is moving through the pipe system. The reduced pressure within the bladder 22 helps reduce the diameter of the liner/bladder assembly which reduces friction between the liner/bladder assembly and the pipe. Further, the reduced pressure within the bladder 22 helps secure the components together as they travel within the pipe system. In one embodiment a lubricant such as soap may be applied to the external sides of the liner/bladder assembly to help reduce friction. In another embodiment the lubricant may be applied to the walls of the pipe to help reduce friction.

Once the launcher 13 is properly positioned with the pipe adjacent to the damaged section of pipe, a fluid such as air is forced through air hose 16 and into the launcher 13 through openings in the second member 14 to inflate the bladder assembly to help position liner assembly against the wall of the pipe as the resin in the liner cures and hardens. The bladder assembly may be deflated by removing air through the air hose 16 or, in some embodiments, through a separate vacuum hose 17 which is also in fluid communication with cavity 50 through an opening in the second member 14. The air hose 16 and/or vacuum hose 17 may be combined with openings/fittings in the second member 14 before the launcher is pushed into the pipe. The hoses 16, 17 may be stored on reels which unwind as the launcher is pushed into the pipe. Conversely, winding up the hoses 16, 17 and/or the positioning member 10 pulls the launcher 13 to the access point when it is time to remove the launcher 13 from the pipe. The bladder assembly may be removed from the pipe after the liner has cured and hardened.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A repair assembly for repairing a pipe, said repair assembly comprising:
a launcher assembly having a flexible positioning member combined with a first member and a second member, wherein the second member is slidable along a length of the positioning member to adjust a distance between the first member and the second member;
a bladder assembly having a first portion combined with the first member and a second portion combined with the second member;
a liner assembly surrounding a portion of the bladder assembly.

2. The repair assembly of claim 1 wherein the bladder assembly includes a main bladder tube and a lateral bladder tube extending from the main bladder tube.

3. The repair assembly of claim 1 wherein the liner assembly includes a main liner member and a lateral liner tube extending from the main liner member.

4. The repair assembly of claim 1 further comprising a securing member surrounding a portion of the liner assembly.

5. The repair assembly of claim 4 wherein the securing member is a hydrophilic gasket.

6. The repair assembly of claim 5 wherein the hydrophilic gasket includes a flange portion and a tubular portion.

7. The repair assembly of claim 1 further comprising an opening in the second member in fluid communication with an inside cavity of the bladder assembly and adapted to receive fluid from a hose for inflating the bladder assembly.

8. The repair assembly of claim 1 wherein the first member and the second member each include a flange to help secure the bladder assembly thereto.

9. The repair assembly of claim 1 further comprising a handle combined with the positioning member to help rotate the positioning member.

10. The repair assembly of claim 1 further comprising a guide member extending from the first member.

11. The repair assembly of claim 10 wherein the positioning member has a longitudinal axis and a distal end portion of the guide member is angled between about thirty and sixty degrees from the longitudinal axis of the positioning member.

12. The repair assembly of claim 10 wherein the guide member has a diameter smaller than a diameter of the positioning member.

13. The repair assembly of claim 1 wherein the positioning member is a sewer cable.

14. The repair assembly of claim 1 further comprising a barrier member around the positioning member and between the first member and the second member.

15. A repair assembly for repairing a pipe, said repair assembly comprising:
a launcher assembly having a flexible positioning member combined with a first member and a second member, wherein the first member includes a guide member and the second member is slidable along a length of the positioning member to adjust a distance between the first member and the second member, a barrier member around the positioning member and between the first member and the second member, wherein the flexible positioning member includes a handle to help rotate the positioning member;
a bladder assembly having a first portion combined with the first member and a second portion combined with the second member;
a liner assembly surrounding a portion of the bladder assembly.

16. The repair assembly of claim 15 wherein the bladder assembly includes a main bladder tube and a lateral bladder tube extending from the main bladder tube.

17. The repair assembly of claim 15 wherein the liner assembly includes a main liner member and a lateral liner tube extending from the main liner member.

18. The repair assembly of claim 15 further comprising a gasket surrounding a portion of the liner assembly.

19. The repair assembly of claim 18 wherein the gasket is a hydrophilic band.

20. The repair assembly of claim 18 wherein the gasket includes a flange portion and a tubular portion.

21. A method for repairing a damaged section of pipe, the method comprising:
taking a launcher assembly having a positioning member combined with a first member and a second member, a bladder assembly combined with the first member and the second member, and a liner assembly impregnated with a resinous material capable of curing and hardening and surrounding at least a portion of the bladder assembly, wherein the positioning member has a proximal end and a distal end;
pushing the launcher assembly into a first pipe using the positioning member;
rotating the proximal end of the positioning member to cause the distal end of the positioning member to rotate in the same direction;
expanding the bladder assembly to press the pipe liner against a wall of the damaged section of pipe;
allowing the resinous material to cure and harden.

22. The method of claim 21 further comprising deflating and removing the bladder assembly from the first pipe.

23. The method of claim 21 wherein the second member includes an opening adapted to receive the positioning member and wherein the method further comprises moving the second member along a length of the positioning member to adjust the distance between the first member and the second member.

24. The method of claim 21 wherein the launcher is positioned adjacent to the damaged section of pipe using only one access point.

25. The method of claim 21 wherein the damaged section of pipe is in a second pipe and the method further comprises pushing the launcher assembly from the first pipe into the second pipe.

26. The method of claim 25 wherein the second pipe connects to the first pipe at a tee or wye junction.

27. The method of claim 25 wherein the launcher assembly further comprises a guide member extending from the first member at an angle that is relative to a longitudinal axis of the positioning member and the method further comprises guiding the launcher assembly into the second pipe by rotating the proximal end of the positioning member to cause the guide member to point toward the second pipe as the launcher approaches the second pipe.

28. The method of claim 21 wherein the first pipe is a cleanout.

29. The method of claim 21 wherein the second pipe is a lateral pipe or a main pipe.
